(19) United States
(12) Patent Application Publication
(10) Pub. No.: US 2026/0326523 A1
(43) Pub. Date: Oct. 22, 2026

(54) SEALING STRUCTURE FOR AUTOMOBILE

(71) Applicants: NISHIKAWA RUBBER CO., LTD., Hiroshima-shi (JP); HONDA MOTOR CO., LTD., Tokyo (JP)

(72) Inventors: Keisuke TAGA, Hiroshima-shi (JP); Atsushi SHIBATA, Tokyo (JP); Hiromu INOUE, Guangzhou (CN)

(21) Appl. No.: 19/640,549

(22) Filed: Apr. 7, 2026

(30) Foreign Application Priority Data
Apr. 22, 2025 (JP) 2025-071015

(51) Int. Cl. B60J 10/84; B60J 10/24; B60J 10/25

(52) U.S. Cl. CPC B60J 10/84; B60J 10/24; B60J 10/25

(57) ABSTRACT

A sealing structure for an automobile includes an inner door opening seal and a glass run. The inner door opening seal couples to a flange provided along a whole circumference of a peripheral edge of a door opening of an automobile body, and makes elastic contact with a door glass when a frameless door is in a closed position. The glass run includes a vertical seal and an inclined seal, couples to a door shell of the door, and receives a vertical part of the door glass. An edge of the flange defines a line closer to the center of the door glass relative to a line defined by an edge of the door glass in an interval between a roof and a beltline through a pillar such that a hollow part of the inner door opening seal continuously makes elastic contact with the door glass.

### CROSS REFERENCE TO RELATED APPLICATION

This application claims the benefit under 35 USC § 119 of JP Patent Application 2025-071015 filed Apr. 22, 2025, the entire disclosure of which is incorporated herein by reference.

### BACKGROUND INFORMATION

The present invention generally relates to a sealing structure for an automobile, and more particularly, to a sealing structure that includes an inner door opening seal and a glass run. The inner door opening seal couples to the whole circumference of a peripheral edge of a door opening of an automobile body of the automobile, and makes elastic contact with an inner-cabin side surface of the door glass when a frameless door is in a closed position. The glass run couples to a door shell of the door for guiding the door glass.

As illustrated in FIG. 9, a glass run 130, which couples to a front side part of a front door FD of a frameless window vehicle 100, and a glass run 140, which couples to a rear side part of a rear door RD, have been used commonly. The glass runs 130, 140 have a V-shape (see, for example, FIG. 2, FIG. 3, FIG. 5, FIG. 6 of Japanese unexamined Patent Publication No. 2020-11604).

As illustrated in FIG. 9, the glass run 130 for the front side couples to a vertical sash FTS, and the rear end of the glass run 130 guides a door glass DG, which is moved upward or downward. The vertical sash FTS is provided on a door shell FDa of the front door FD, is a channel-shaped portion that has an opening closer to the door glass (side glass) DG, and extends in an upper-lower direction.

The front end of the glass run 130 is fit into the peripheral edge of a mirror base MB, which supports a side mirror (illustration omitted).

The glass run 140 for the rear side couples to a vertical sash RTS, and the front end of the glass run 140 guides the door glass DG. The vertical sash RTS is provided on a door shell RDa of the rear door RD, is a channel-shaped portion, and extends in the upper-lower direction.

The rear end of the glass run 140 is fit into the peripheral edge of a fixed window glass SG.

The inner door opening seal is required to bridge the step between the door glass and an adjacent member. The step is a space that has a substantially triangular-shaped cross section between the door glass and the adjacent member, and is where water ingress occurs (see, for example, FIG. 5, FIG. 6, FIG. 7 of Japanese unexamined Utility Model Application Publication No. 61-67016).

The space can lead to seal discontinuity. Also, the space can lead to lack of sealing performance due to variations, that is lower robustness.

To solve the above problems, it is an object of the present invention to provide a sealing structure improved in the sealing performance and robustness for an automobile.

### SUMMARY OF THE INVENTION

To achieve the above object, an aspect of the present invention provides a sealing structure for an automobile. The structure includes an inner door opening seal (10) and a glass run (30). The inner door opening seal (10) couples to the whole circumference of the peripheral edge of a door opening (FDO) of an automobile body of the automobile, and makes elastic contact with an inner-cabin side surface of a door glass (DG) when a door (FD) of the automobile is in a closed position. The door glass (DG) has the edge (DGe), the vertical part (DGt), and the upper end (DGu). The glass run (30) couples to the portion of the door (FD) opposite the portion of the peripheral edge of the door opening (FDO) of the automobile body that slopes downward toward a beltline (BL) from a roof through a pillar.

The inner door opening seal (10) includes an installation member (11) and a hollow part (16). The installation member (11) couples to a flange (FF). The flange (FF) has the edge (FFe). The flange (FF) protrudes toward the inner side of the peripheral edge of the door opening (FDO) of the automobile body. The hollow part (16) is integrally formed with the outer-cabin side surface of the installation member (11). The hollow part (16) provides an elastic seal against the inner-cabin side surface of the door glass (DG).

The glass run (30) includes a vertical seal (40) and an inclined seal (50). The vertical seal (40) has the upper end (40Ue) and includes a channel (41). The vertical seal (40) couples to a channel-shaped portion of a door shell (FDa) of the door (FD). The channel (41) has the bottom portion. The channel (41) has an opening closer to the door glass (DG), and extends in an upper-lower direction. The channel (41) receives the vertical part (DGt) of the door glass (DG) and is slidably brought into contact. The channel-shaped portion has an opening closer to the door glass (DG), and extends in the upper-lower direction.

The inclined seal (50) is connected with the upper end (40Ue) of the vertical seal (40) and extends diagonally downward toward the beltline (BL) along the pillar.

The edge (FFe) of the flange (FF) defines a line closer to the center (DGc) of the door glass (DG) relative to a line defined by the edge (DGe) of the door glass (DG) in an interval between the roof and the beltline (BL) through the pillar such that the hollow part (16) of the inner door opening seal (10) continuously makes elastic contact with the door glass (DG).

In addition, according to an aspect of the present invention, the structure further includes an outer door opening seal (20). The outer door opening seal (20) couples to the portion of the peripheral edge of the door opening (FDO) of the automobile body of the automobile between the roof and the beltline (BL) through the pillar. The outer door opening seal (20) is closer to the exterior of the automobile than the inner door opening seal (10). The outer door opening seal (20) provides an elastic seal against the vicinity of the upper end (DGu) of the door glass (DG).

When the door (FD) of the automobile is in the closed position, the inclined seal (50) of the glass run (30) makes elastic contact with the outer door opening seal (20).

In addition, according to an aspect of the present invention, the outer door opening seal (20) couples to a retainer (FRT). The retainer (FRT) is provided on the peripheral edge of the door opening (FDO) of the automobile body of the automobile. The retainer (FRT) faces a garnish (FGA). The garnish (FGA) is provided closer to the exterior of the automobile than the retainer (FRT).

The inclined seal (50) of the glass run (30) includes an outer-cabin side seal lip (51). When the door (FD) of the automobile is in the closed position, the outer-cabin side seal lip (51) provides an elastic seal against the garnish (FGA).

In addition, according to an aspect of the present invention, the outer door opening seal (20) includes a hollow seal member (25). The hollow seal member (25) is provided on the portion of the outer door opening seal (20) opposite the portion of the glass run (30) where the inclined seal (50) is provided. The hollow seal member (25) protrudes downward.

The inclined seal (50) of the glass run (30) includes a protrusion (52). When the door (FD) of the automobile is in the closed position, the protrusion (52) makes elastic contact with the hollow seal member (25).

In addition, according to an aspect of the present invention, the outer-cabin side seal lip (51) and the protrusion (52) of the inclined seal (50) of the glass run (30) define a channel (50M). When the door (FD) is in the closed position, the channel (50M) is out of contact with the garnish (FGA) and the outer door opening seal (20).

In addition, according to an aspect of the present invention, the bottom portion of the channel (41) of the vertical seal (40) of the glass run (30) and the edge (DGe) of the door glass (DG) define a space (40S). The space (40S) separates the vertical part (DGt) of the door glass (DG) from the bottom portion of the channel (41) when the door glass (DG) is moved.

Symbols in parentheses show constituents or items corresponding to the drawings.

According to the sealing structure of the present invention of the automobile, the edge of the flange to which the inner door opening seal couples defines the line closer to the center of the door glass relative to the line defined by the edge of the door glass in the interval between the roof and the beltline through the pillar such that the hollow part of the inner door opening seal continuously makes elastic contact with the door glass. The hollow part of the inner door opening seal makes elastic contact only with the door glass, and is out of contact with the glass run that couples to the door shell of the door and receives the vertical part of the door glass.

The hollow part of the inner door opening seal continuously makes elastic contact only with the door glass without a step. This prevents degradation in sealing performance due to the step as in the related art.

This removes the impact of variations in the elastic contact of the hollow part of the inner door opening seal, and improves robustness.

In addition, the structure further includes the outer door opening seal that couples to the portion of the peripheral edge of the door opening of the automobile body of the automobile between the roof and the beltline through the pillar. The outer door opening seal is closer to the exterior of the automobile than the inner door opening seal. The outer door opening seal provides the elastic seal against the vicinity of the upper end of the door glass. When the door is in the closed position, the inclined seal of the glass run makes elastic contact with the outer door opening seal. This prevents water ingress from an upper side of the door glass.

In addition, the garnish is provided closer to the exterior of the automobile than the retainer to which the outer door opening seal couples. Also, the inclined seal of the glass run includes the outer-cabin side seal lip that provides the elastic seal against the garnish when the door is in the closed position. This improves sealing performance.

In addition, the outer door opening seal includes the hollow seal member that is provided on the portion of the outer door opening seal opposite the portion of the glass run where the inclined seal is provided. The hollow seal member protrudes downward. Also, the inclined seal of the glass run includes the protrusion that makes elastic contact with the hollow seal member when the door is in the closed position. This improves the sealing performance.

The inclined seal of the glass run lacks a so-called dropping function by the door glass. But a similar effect is achieved by employing a larger hollow shaped part as the hollow seal member of the outer door opening seal, which makes elastic contact with the protrusion of the glass run. This enlarges the amount of upward deflection, providing the same effect as the dropping function. The protrusion may be solid or hollow, but a hollow protrusion provides a softer way of elastic contact.

In addition, the outer-cabin side seal lip and the protrusion of the inclined seal of the glass run define the channel that is out of contact with the garnish and the outer door opening seal when the door is in the closed position. If water ingress occurs on the inner-cabin side of the outer-cabin side seal lip, water is drained toward the lower side of the automobile by the channel. This improves drainage performance.

In addition, the bottom portion of the channel of the vertical seal of the glass run and the edge of the door glass define the space that separates the vertical part of the door glass from the bottom portion of the channel of the vertical seal when the door glass is moved. If water ingress occurs at the space between the vertical seal of the glass run and the vertical part of the door glass, water is drained toward the lower side of the automobile through the space. This improves drainage performance.

### BRIEF DESCRIPTION OF THE DRAWINGS

FIG. 1 is an enlarged side view of the main components of a sealing structure according to an embodiment of the present invention for an automobile on a left-side door.

FIG. 2 is an enlarged cross-sectional view taken along line II-II in FIG. 1.

FIG. 3 is an enlarged cross-sectional view taken along line III-III in FIG. 1.

FIG. 4 is an enlarged cross-sectional view taken along line IV-IV in FIG. 1.

FIG. 5 is an enlarged cross-sectional view taken along line V-V in FIG. 1.

FIG. 6 is an enlarged cross-sectional view taken along line VI-VI in FIG. 1.

FIG. 7 is an enlarged side view of a glass run that couples to the left-side door in the sealing structure according to the embodiment.

FIG. 8 is an enlarged perspective view of the glass run in FIG. 7 from a different angle.

FIG. 9 is a left-external side view of an automobile.

### DETAILED DESCRIPTION

Referring to the drawins, a sealing structure according to an embodiment of the present invention for an automobile will be described. When constituents or items correspond to those in prior arts, the same symbols are used.

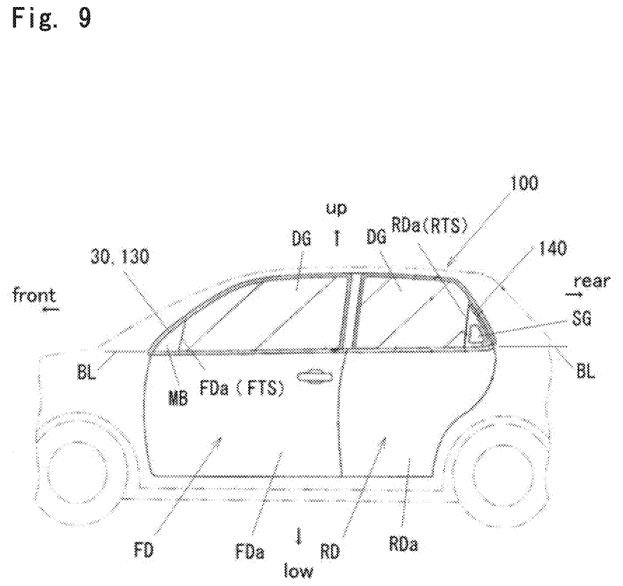

As illustrated in FIG. 9, this embodiment relates to the sealing structure around a glass run 30, which couples to a front side part of a front door FD of a frameless window vehicle 100 and has a V-shape.

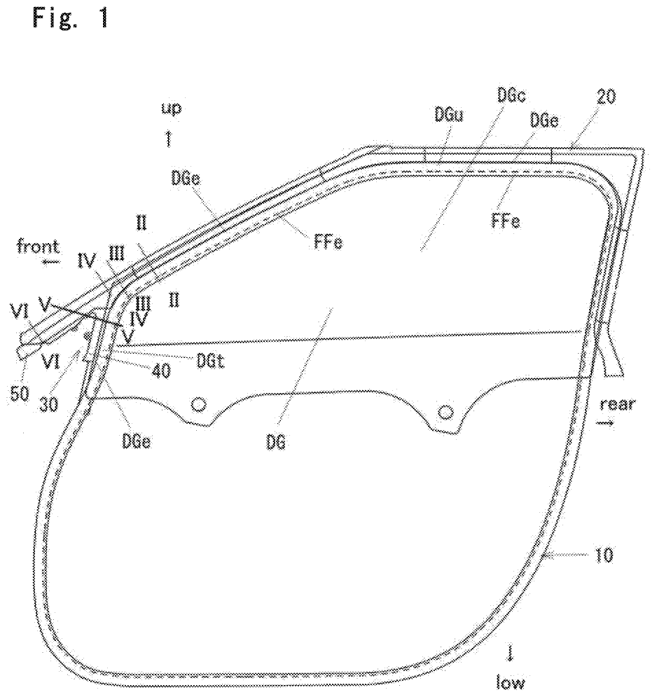

As illustrated in FIG. 1, the sealing structure includes an inner door opening seal 10, an outer door opening seal 20, and the glass run 30.

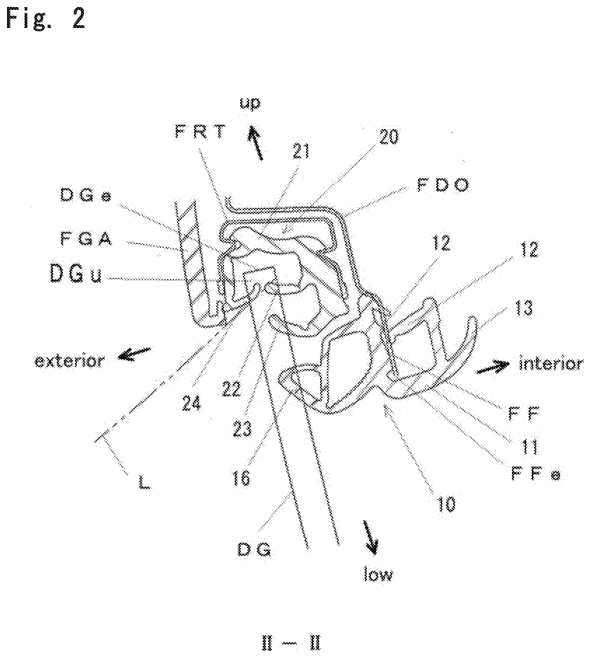

As illustrated in FIG. 1 to FIG. 6 and FIG. 9, the inner door opening seal 10 couples to the whole circumference of the peripheral edge of a door opening FDO of an automobile body of the automobile, and makes elastic contact with the inner-cabin side surface of a door glass DG when the front door FD is in a closed position. The inner door opening seal 10 includes an installation member 11 and a hollow part 16. The double-dotted chain line in FIG. 2 to FIG. 6 indicates the entry trajectory L of the door glass DG in a fully raised position when the front door FD is in the closed position.

The installation member 11 has a substantially U-shape that opens toward a flange FF and is inserted in the flange FF. The flange FF protrudes toward the inner side of the peripheral edge of the door opening FDO, that is toward the center DGc of the door glass DG. The installation member 11 has plural holding members 12 provided inside for holding the flange FF. The holding members 12 may have any shape that holds the flange FF, for example a lip shape, a claw shape, or a protrusion shape. The installation member 11 has a lip 13 provided closer to the interior of the automobile. The lip 13 makes elastic contact with the automobile body.

The hollow part 16 is integrally formed with the outer-cabin side surface of the installation member 11 and protrudes toward the exterior of the automobile. When the front door FD is in the closed position, the hollow part 16 directly makes elastic contact with the inner-cabin side surface of the door glass DG. In this embodiment, the hollow part 16 has a double-hollow structure. Alternatively, the hollow part 16 may have a single-hollow structure.

The inner door opening seal 10 may be formed by extrusion molding. Materials usable for the hollow part 16 include, for example, a combination of EPDM solid rubber and EPDM sponge rubber, non-foamed thermoplastic elastomer (TPE), and foamed thermoplastic elastomer (TPE). Applicable materials are not limited to these materials.

Materials usable for the installation member 11 include, for example, EPDM solid rubber and non-foamed thermoplastic elastomer (TPE) with a core made of metal, for example, embedded. Applicable materials are not limited to these materials.

An outer door opening seal 20 is provided closer to the exterior of the automobile than the inner door opening seal 10. The outer door opening seal 20 couples to a channel of a retainer FRT. The retainer FRT is provided on the peripheral edge of the door opening FDO. When the front door FD is in the closed position, the outer door opening seal 20, which is provided above the inner door opening seal 10 and closer to the exterior of the automobile than the inner door opening seal 10, slopes downward toward a beltline BL from a roof through a pillar on the front side part of the front door FD, and is curved downward from the roof on the rear side part of the front door FD. As illustrated in FIG. 2 to FIG. 6, the retainer FRT faces a decorative garnish FGA. The garnish FGA is provided closer to the exterior of the automobile than the retainer FRT.

As illustrated in FIG. 2, part of the outer door opening seal 20 formed by extrusion-molding includes an installation member 21. The installation member 21 has a substantially U-shape that opens downward, and includes two inner-cabin side lips 22, 23 aligned in an upper-lower direction (first inner-cabin side lip 22, second inner-cabin side lip 23), and an outer-cabin side lip 24. The installation member 21 receives the upper end DGu of the door glass DG. When the door glass DG is moved upward, the inner-cabin side lips 22, 23 make elastic contact with the inner-cabin side surface of the door glass DG, and the outer-cabin side lip 24 makes elastic contact with the outer-cabin side surface of the door glass DG.

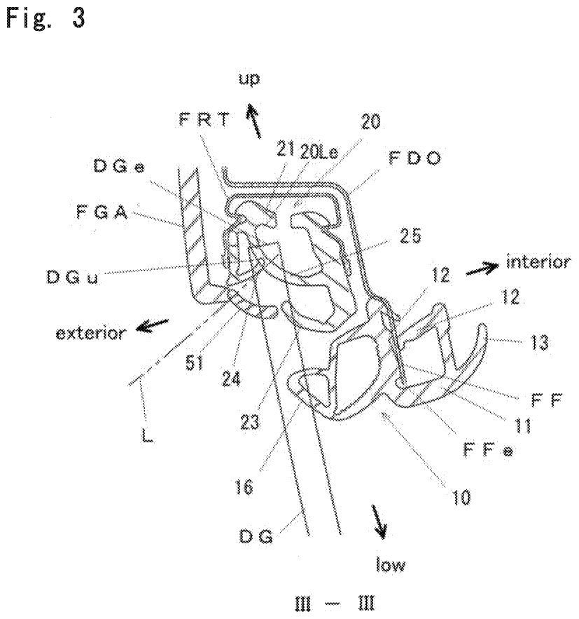

As illustrated in FIG. 3 to FIG. 6, part of the outer door opening seal 20 formed by die-molding, which is opposite the portion where an inclined seal 50 of the glass run 30 is provided, includes a hollow seal member 25. The hollow seal member 25 is curved downward. The inner-cabin side lips 22, 23, provided on the lower part of the installation member 21, continuously extend between the extrusion-molded part and the die-molded part. The first inner-cabin side lip 22, which is provided on an upper side part of the extrusion-molded part, is extended to the outer-cabin side part of the bottom portion of the installation member 21, and gradually transitions into the hollow seal member 25 in the die-molded part.

Materials usable for the extrusion-molded part of the outer door opening seal 20 include, for example, a combination of EPDM solid rubber and EPDM sponge rubber, non-foamed thermoplastic elastomer (TPE), and foamed thermoplastic elastomer (TPE). Applicable materials are not limited to these materials.

Materials usable for the die-molded part of the outer door opening seal 20 include, for example, EPDM solid rubber and non-foamed thermoplastic elastomer (TPE). Applicable materials are not limited to these materials.

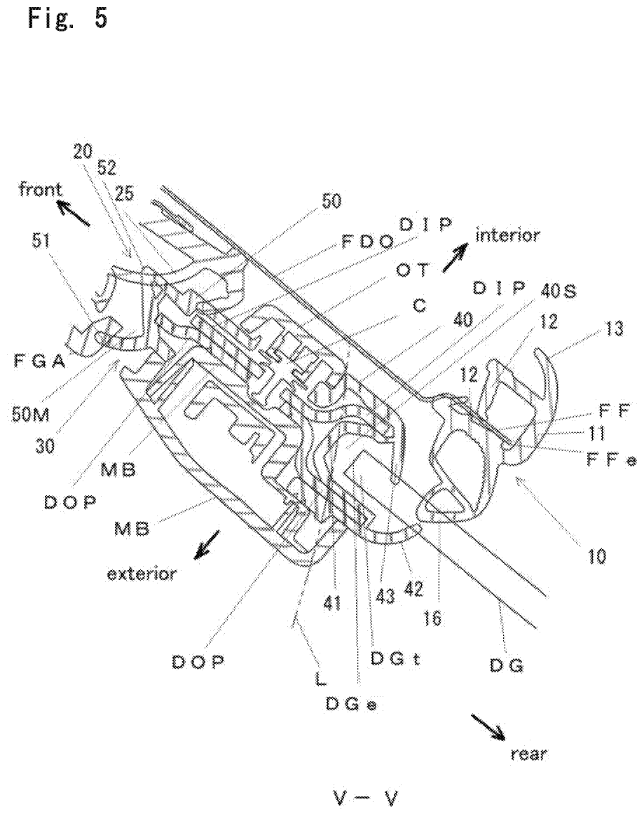

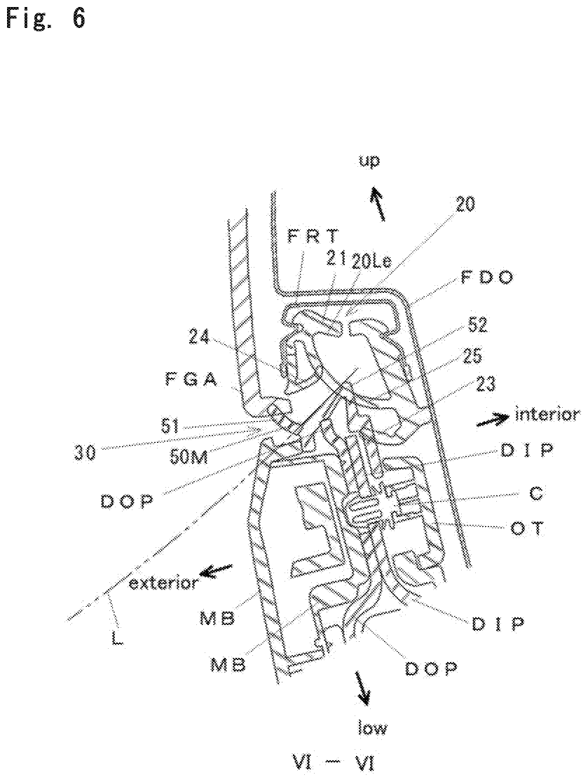

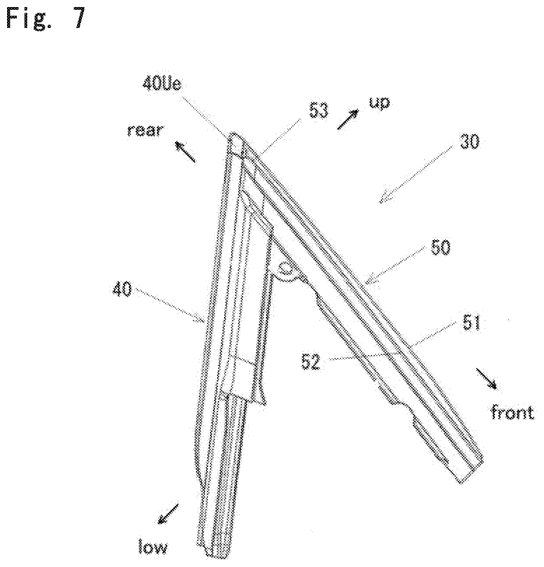

As illustrated in FIG. 7, the glass run 30 has a V-shape, and includes a vertical seal 40 and an inclined seal 50. The glass run 30 is fit into the peripheral edge of a mirror base MB, which supports a side mirror (illustration omitted). As illustrated in FIG. 5 and FIG. 6, the glass run 30 and the mirror base MB are fixed by an outsert OT and a clip C.

As illustrated in FIG. 1 and FIG. 9, the vertical seal 40 couples to the rear side of a channel-shaped portion of a door shell FDa of the front door FD. The channel-shaped portion has an opening closer to the door glass DG, and extends in the upper-lower direction. The channel-shaped portion may be formed by a door inner panel DIP and a door outer panel DOP of the door shell FDa as illustrated in FIG. 5 and FIG. 6, or by inserting another member that has an opening closer to the door glass DG, such as a sash, between the door inner panel DIP and the door outer panel DOP as illustrated in FIG. 3 of Japanese unexamined Patent Publication No. 2020-11604. The channel-shaped portion has the opening closer to the rear side of the automobile, to which a protrusion of the vertical seal 40 couples. The protrusion of the vertical seal 40 extends toward the front side of the automobile.

As illustrated in FIG. 5, the vertical seal 40 has a channel 41 provided closer the rear side of the automobile. The channel 41 has an opening closer to the door glass DG, and extends in the upper-lower direction. The channel 41 receives the vertical part DGt of the door glass DG and is slidably brought into contact when the door glass DG is moved. The channel 41 has an outer-cabin seal lip 42 provided on the outer-cabin side, and an inner-cabin seal lip 43 provided on the inner-cabin side. The outer-cabin seal lip 42 makes elastic contact with the outer-cabin side surface of the vertical part DGt, received by the channel 41, and the inner-cabin seal lip 43 makes elastic contact with the inner-cabin side surface.

As illustrated in FIG. 5, a rear side surface of the bottom portion of the vertical seal 40, which has the channel 41 provided, and an edge DGe of the door glass DG define a space 40S. The space 40S separates the vertical part DGt from the bottom portion of the vertical seal 40 when the door glass DG is moved. If water ingress occurs at the space 40S between the vertical seal 40 and the vertical part DGt, water is drained toward the lower side of the automobile through the space 40S.

The inclined seal 50 is connected with an upper end 40Ue of the vertical seal 40. As illustrated in FIG. 1, the inclined seal 50 as coupled to the door shell FDa extends parallel to the outer door opening seal 20, which is located above the inclined seal 50. In other words, the inclined seal 50, in the same manner as the outer door opening seal 20, extends diagonally downward toward the beltline BL along the pillar when the front door FD is in the closed position.

As illustrated in FIG. 3 to FIG. 8, the inclined seal 50 has an outer-cabin side seal lip 51 provided on the outer-cabin side closer to the front side of the automobile and a protrusion 52 provided on the inner-cabin side closer to the front side of the automobile. The outer-cabin side seal lip 51 and the protrusion 52 extend in the upper-lower direction. The protrusion 52 is hollow and has a triangular-shaped cross section. The protrusion 52 has an inner-cabin side seal lip 53 provided on the upper part. The inner-cabin side seal lip 53 extends further upward than the protrusion 52.

As illustrated in FIG. 3 to FIG. 6, the outer-cabin side seal lip 51 is positioned to provide an elastic seal against the garnish FGA when the front door FD is in the closed position. The outer-cabin side seal lip 51 is the only member of the glass run 30 that appears on FIG. 3.

As illustrated in FIG. 5 and FIG. 6, the protrusion 52 is positioned to make elastic contact with the hollow seal member 25 when the front door FD is in the closed position.

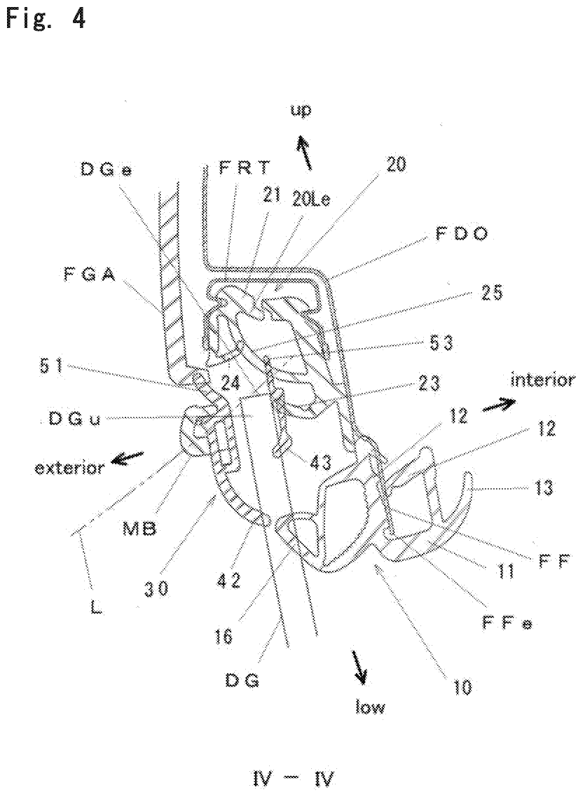

As illustrated in FIG. 4, the inner-cabin side seal lip 53, which extends further upward than the protrusion 52, is positioned to make elastic contact with the hollow seal member 25 on the upper side part of the inclined seal 50, that is on the upper end 40Ue where the inclined seal 50 is connected with the vertical seal 40.

Materials usable for the glass run 30, which includes the vertical seal 40 and the inclined seal 50, include, for example, EPDM solid rubber and non-foamed thermoplastic elastomer (TPE), and the glass run 30 may be formed by die-molding. Applicable materials are not limited to these materials.

The glass run 30 as the whole may be formed by die-molding. Alternatively, part of the glass run 30 may be formed by extrusion-molding, and the remaining part may be formed by die-molding.

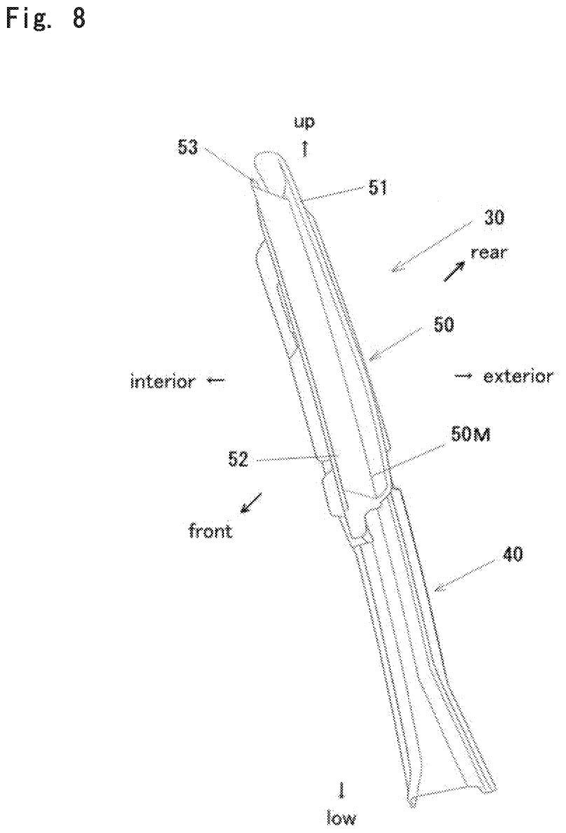

As illustrated in FIG. 8, the outer-cabin side seal lip 51 and the protrusion 52 define a channel 50M. As illustrated in FIG. 5 and FIG. 6, the channel 50M is out of contact with the garnish FGA and the outer door opening seal 20 when the front door FD is in the closed position. If water ingress occurs at the space between the outer-cabin side seal lip 51 and the protrusion 52, the channel 50M functions as a flow path to drain water toward the lower side of the automobile.

As illustrated in FIG. 4 to FIG. 6, the hollow seal member 25 makes elastic contact with the protrusion 52 on the portion of the outer door opening seal 20 opposite the portion where the inclined seal 50 is provided. As illustrated in FIG. 3, the hollow seal member 25 is positioned to provide an elastic seal against the vicinity of the upper end DGu on the portion of the outer door opening seal 20 opposite the portion closer to the rear side of the automobile than the glass run 30 without the installation member as the main body of the inclined seal 50.

As illustrated in FIG. 1, an edge FFe of the flange FF, to which the inner door opening seal 10 couples, defines a line closer to the center DGc of the door glass DG relative to a line defined by the edge DGe in an interval between the roof and the beltline BL through the pillar. More specifically, the edge FFe is positioned downward relative to the upper side part of the door glass DG opposite the roof, the edge FFe is positioned obliquely rearward and downward relative to part of the door glass DG that slopes downward toward the front side part from the upper side part, and the edge FFe is positioned rearward relative to the front side part of the door glass DG opposite the pillar. This allows the hollow part 16 to make elastic contact only with the door glass DG continuously as illustrated in FIG. 2 to FIG. 5.

In this embodiment, the upper end DGu indicates the upper ends of the upper side part of the door glass DG opposite the roof and part of the door glass DG that slopes downward toward the front side part from the upper side part as illustrated in FIG. 1 to FIG. 4. The vertical part DGt indicates the front side part of the door glass DG, which couples to the vertical seal 40 as illustrated in FIG. 1 to FIG. 5. The line defined by the edge DGe indicates a continuous line extending between the extreme end of the upper end DGu and the extreme end of the vertical part DGt.

According to the sealing structure in this embodiment of the present invention, the hollow part 16 continuously makes elastic contact only with the door glass DG without the step. This prevents degradation in sealing performance due to the step as in the related art.

This removes the impact of variations in the elastic contact of the hollow part 16, and improves robustness.

In addition, the structure further includes the outer door opening seal 20 provided on the portion of the peripheral edge of the door opening FDO between the roof and the beltline through the pillar. The outer door opening seal 20 is closer to the exterior of the automobile than the inner door opening seal 10. The outer door opening seal 20 provides the elastic seal against the vicinity of the upper end DGu. The inclined seal 50 makes elastic contact with the outer door opening seal 20 when the front door FD is in the closed position. This prevents water ingress from the upper side of the door glass.

As illustrated in FIG. 3 to FIG. 8, the inclined seal 50 has the outer-cabin side seal lip 51 provided on the outer-cabin side and the protrusion 52 provided on the inner-cabin side. The outer-cabin side seal lip 51 makes elastic contact with the garnish FGA when the front door FD is in the closed position. The protrusion 52 makes elastic contact with the hollow seal member 25. This improves sealing performance. The protrusion 52 may be hollow and have the triangular-shaped cross section as illustrated in FIG. 5 and FIG. 6, or a lip-shape in the same manner as the inner-cabin side seal lip 53 in FIG. 4.

In this embodiment, the glass run 30 couples to the front side part of the front door FD. Alternatively, the glass run 30 may couple to the rear side part of a rear door RD. In this embodiment, the glass run 30 is fit into the peripheral edge of the mirror base MB. Alternatively, the glass run 30 may be fit into the peripheral edge of a fixed window glass SG in the same manner as a glass run 140 in the related art.

We claim:

1. A sealing structure for an automobile, the structure comprising:
an inner door opening seal which couples to a whole circumference of a peripheral edge of a door opening of an automobile body of the automobile, the inner door opening seal being configured to make elastic contact with an inner-cabin side surface of a door glass when a door of the automobile is in a closed position, the door glass having an edge, a vertical part, and an upper end, and the inner door opening seal including:
an installation member which is configured to couple to a flange,
the flange having an edge, and the flange protruding toward an inner side of the peripheral edge of the door opening of the automobile body; and
a hollow part which is integrally formed with an outer-cabin side surface of the installation member, and the hollow part being configured to provide an elastic seal against the inner-cabin side surface of the door glass; and
a glass run which couples to a portion of the door opposite a portion of the peripheral edge of the door opening of the automobile body that slopes downward toward a beltline from a roof through a pillar, the glass run including:
a vertical seal which has an upper end, the vertical seal including a channel, and the vertical seal being configured to couple to a channel-shaped portion of a door shell of the door,
the channel of the vertical seal having a bottom portion, the channel having an opening closer to the door glass, the channel extending in an upper-lower direction, and the channel being configured to receive the vertical part of the door glass and to be slidably brought into contact,
the channel-shaped portion of the door shell having an opening closer to the door glass, and the channel-shaped portion extending in the upper-lower direction; and
an inclined seal which is connected with the upper end of the vertical seal, and the inclined seal extending diagonally downward toward the beltline along the pillar, wherein:
the edge of the flange defines a line closer to the center of the door glass relative to a line defined by the edge of the door glass in an interval between the roof and the beltline through the pillar such that the hollow part of the inner door opening seal continuously makes elastic contact with the door glass.

2. The sealing structure as claimed in claim 1, further comprising an outer door opening seal, the outer door opening seal being configured to couple to the portion of the peripheral edge of the door opening of the automobile body of the automobile between the roof and the beltline through the pillar, the outer door opening seal being provided closer to the exterior of the automobile than the inner door opening seal, and the outer door opening seal being configured to provide an elastic seal against vicinity of the upper end of the door glass, wherein
when the door is in the closed position, the inclined seal of the glass run makes elastic contact with the outer door opening seal.

3. The sealing structure as claimed in claim 2, wherein
the outer door opening seal couples to a retainer provided on the peripheral edge of the door opening of the automobile body of the automobile, the retainer faces a garnish provided closer to the exterior of the automobile than the retainer, and
the inclined seal of the glass run includes an outer-cabin side seal lip configured to provide an elastic seal against the garnish when the door is in the closed position.

4. The sealing structure as claimed in claim 3, wherein
the outer door opening seal includes a hollow seal member, the hollow seal member is provided on the portion of the outer door opening seal opposite the portion of the glass run where the inclined seal is provided, the hollow seal member protrudes downward, and
the inclined seal of the glass run includes a protrusion configured to make elastic contact with the hollow seal member when the door is in the closed position.

5. The sealing structure as claimed in claim 4, wherein
the outer-cabin side seal lip and the protrusion of the inclined seal of the glass run define a channel, and
the channel is out of contact with the garnish and the outer door opening seal when the door is in the closed position.

6. The sealing structure as claimed in claim 1, wherein
the bottom portion of the channel of the vertical seal of the glass run and the edge of the door glass define a space that separates the vertical part of the door glass from the bottom portion of the channel when the door glass is moved.

7. The sealing structure as claimed in claim 2, wherein
the bottom portion of the channel of the vertical seal of the glass run and the edge of the door glass define a space that separates the vertical part of the door glass from the bottom portion of the channel when the door glass is moved.
